(19) United States
(12) Patent Application Publication
(10) Pub. No.: US 2014/0168067 A1
(43) Pub. Date: Jun. 19, 2014

(54) ELECTRONIC DEVICE AND METHOD FOR CHARACTER INPUT

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: CHUN-SHENG CHEN, New Taipei (TW); JING WANG, Wuhan (CN); DAO-WEI LI, Wuhan (CN); XI-HUAI HE, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/101,339

(22) Filed: Dec. 10, 2013

(30) Foreign Application Priority Data
Dec. 17, 2012 (CN) 2012105474202

(51) Int. Cl. G06F 3/03; G06F 3/01

(52) U.S. Cl. CPC G06F 3/03; G06F 3/018
USPC 345/156

(57) ABSTRACT

A method for character input using an electronic device includes recording movement displacements of the electronic device using a sensor when a character input function of the electronic device is invoked. The method determines movement coordinates based on a predetermined coordinate system according to the movement displacements. When the electronic device stops moving for a predetermined time duration, it is determined that one character has been inputted. A movement path is determined according to the movement coordinates and a recording sequence of the movement displacements, and a character corresponding to the movement path is generated and displayed.

### BACKGROUND

1. Technical Field

Embodiments of the present disclosure relate to data input technology, and particularly to an electronic device and a method for character input using the electronic device.

2. Description of Related Art

Data input can be implemented using a physical keyboard, a virtual keyboard, handwriting input, or mouse input. However, these kinds of data inputs are limited to be executed on the physical keyboard or a touch panel of an electronic device. Therefore, an improved method for character input using the electronic device is desired.

### BRIEF DESCRIPTION OF THE DRAWINGS

FIG. 1 is a block diagram of one embodiment of a connection between two electronic devices.

FIG. 2 is a block diagram of one embodiment of an electronic device comprising a character input system.

FIG. 3 is a schematic diagram of one embodiment of an input interface to input characters.

FIG. 4 is a flowchart of one embodiment of a method for character input using the character input system of FIG. 2.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

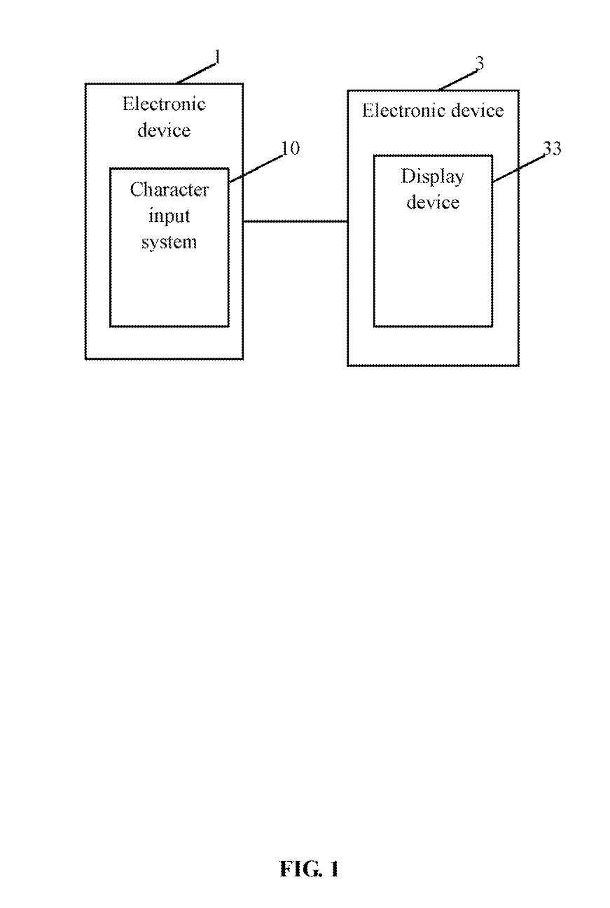

FIG. 1 is a block diagram of one embodiment of a connection between two electronic devices, such as an electronic device 1 and an electronic device 3. The electronic devices 1 and 3 can be a communication device (e.g., a mobile phone), a tablet computer, a personal digital assistant, or any other computing device. The electronic device 1 may be connected to the electronic device 3 through a wireless network (e.g., WIFI, BLUETOOTH) or a data cable (e.g., a Universal Serial Bus (USB) cable).

In some embodiments, the electronic device 1 comprises a character input system 10. The character input system 10 may detect a movement path of the electronic device 1 when a user holds the electronic device 1 to trace out/write characters in the air, and determine input corresponding characters according to the movement path. The characters comprise, but are not limited to Chinese characters, alphabet, numbers, and/or symbols.

By utilizing the character input system 10, the determined characters may be inputted into the electronic device 1 directly, or transmitted to the electronic device 3 and displayed on a display device 33 of the electronic device 3. Detailed descriptions are provided below. Accordingly, the electronic device 1 comprising the character input system 10 can be used to input characters into the electronic device 3 according to user gestures by holding the electronic device 1.

For example, the electronic device 1 is a mobile phone and the electronic device 3 is a computer, the user may hold the electronic device 1 to trace out corresponding characters in the air, so as to input the corresponding characters to the electronic device 3.

In other embodiments, the character input system 10 may be installed in the electronic device 3, so as to input characters into the electronic device 3 or the electronic device 1 without the character input system 10. For simplification, the character input system 10 is applied in the electronic device 1 as follows.

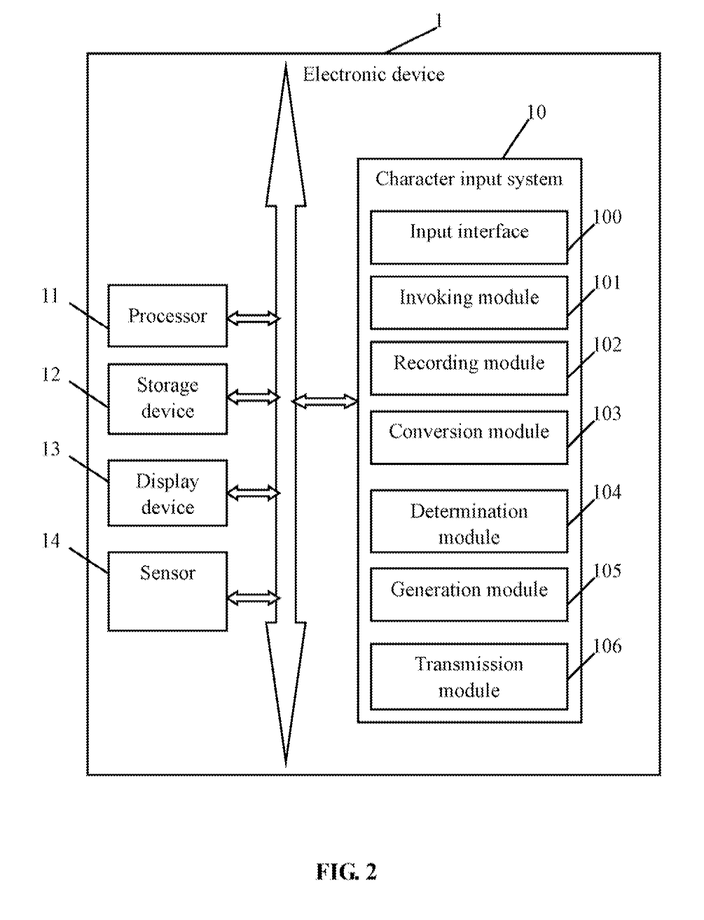

FIG. 2 is a block diagram of one embodiment of the electronic device 1 comprising the character input system 10. The electronic device 1 includes at least one processor 11, a storage device 12, a display device 13, and a sensor 14. In other embodiments, the electronic device 1 can include more or fewer components than illustrated, or have a different configuration of the various components.

The at least one processor 11 is used to execute the character input system 10 and other applications, such as an operating system installed in the electronic device 1. The storage device 12 stores one or more programs, such as the operating system and applications of the electronic device 1. The storage device 12 can be a storage card, such as a memory stick, a smart media card, a compact flash card, a secure digital card, or any other type of memory storage device.

The display device 13 displays visible data, such as characters, videos, images, or the like. The sensor 14 is used to detect displacement parameters of the electronic device 1. For example, the sensor 14 is a gravity sensor or a displacement sensor.

The character input system 10 provides an input interface 100, which can receive and display the characters or the movement path of the electronic device 1. Depending on the embodiments, the character input system 10 provides a character input function, which can be invoked to start inputting the characters, or be disabled to stop inputting the characters.

The character input system 10 may include computerized instructions in the form of one or more programs that are executed by the at least one processor 11 and stored in the storage device 12. In one embodiment, the character input system 10 includes one or more modules, for example, an invoking module 101, a recording module 102, a conversion module 103, a determination module 104, a generation module 105, and a transmission module 106. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

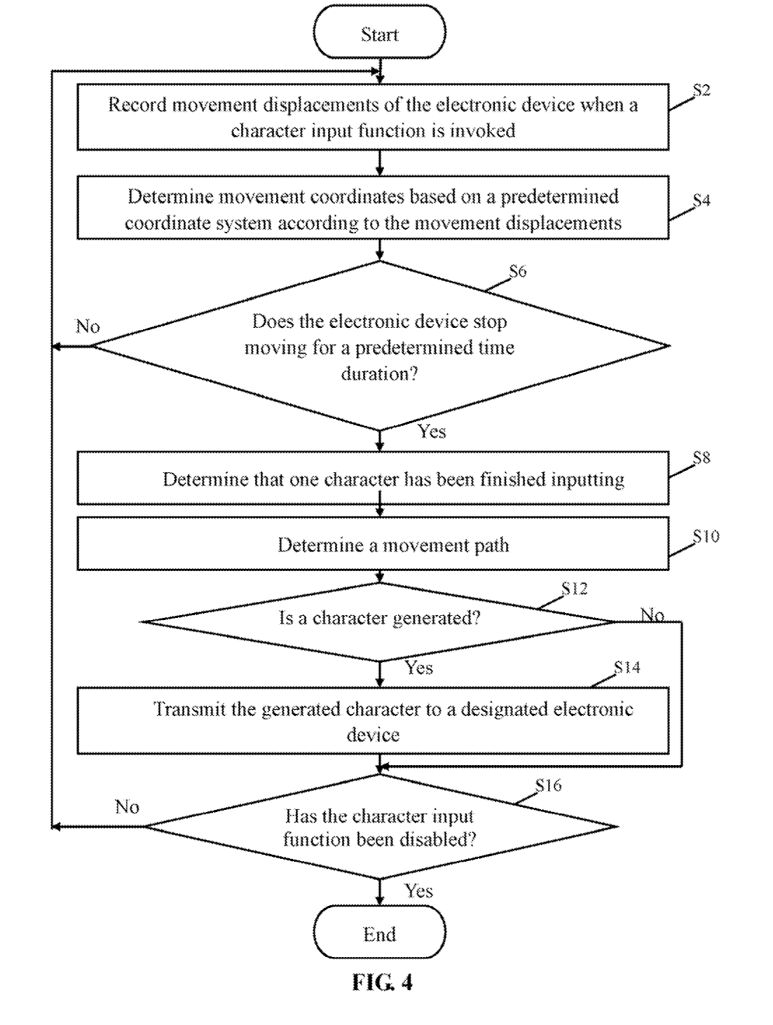

FIG. 4 is a flowchart of one embodiment of a method for character input using the character input system 10 of FIG. 2. Depending on the embodiment, additional steps may be added, others removed, and the ordering of the steps may be changed.

A hotkey for enabling/invoking or disabling the character input function of the character input system 10 can be preset using the invoking module 101, before executing the method for character input using the character input system 10. The hotkey may be a physical keystroke, a virtual keystroke or a predetermined icon, which can be shown on a user interface of the electronic device 1.

In step S2, when the character input function of the character input system 10 is invoked, the recording module 102 records movement displacements of the electronic device 1 using the sensor 14. As mentioned above, the user may hold the electronic device 1 to trace out one or more characters in the air. For simplification, a user gesture, is referred to as a user holding the electronic device 1 to trace out one character in the air. One user gesture corresponds to one character. In other embodiments, one user gesture may correspond to multiple characters.

The sensor 14 detects a plurality of movement displacements of the electronic device 1 when the electronic device 1 is moving, and the recording module 102 acquires the movement displacements from the sensor 14. The sensor 14 has an embedded coordinate system, which can be a two dimensional (2D) or a three dimensional (3D) coordinate system. As people generally writes the characters in a 2D plane, thus, according to handwriting habits, a horizontal axis and a vertical axis are selected. The horizontal axis is assumed to be an X-axis, and the vertical axis is assumed to be a Y-axis. Then, the movement displacements occurred on the X-axis and the Y-axis are recorded by the recording module 102.

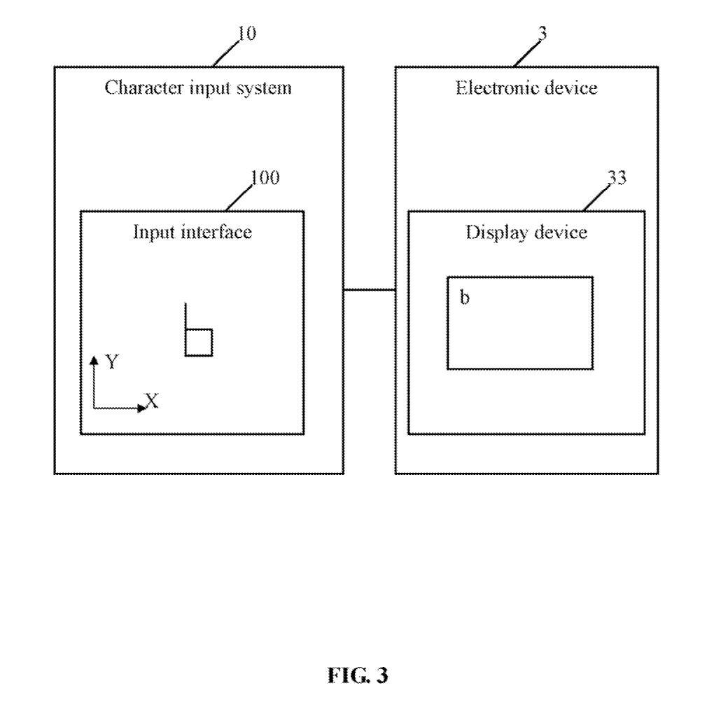

In step S4, the conversion module 103 determines movement coordinates based on a predetermined coordinate system according to the movement displacements. In some embodiments, the predetermined coordinate system is a 2D coordinate system, which may be established based on the input interface 100 as shown in FIG. 3, or based on the display device 13 of the electronic device 1. For example, a width of the input interface 100 is an X-axis of the predetermined coordinate system, and a length of the input interface 100 is a Y-axis of the predetermined coordinate system.

In detail, the conversion module 103 determines an origin of the predetermined coordinate system to be a first point of a first movement displacement, determines a second point according to the first movement displacement and the first point, and determines a third point according to a second movement displacement and the second point. The conversion module 103 continues to determine the other points corresponding to the other movement displacements, until all of the movement displacements have been determined.

In step S6, the determination module 104 determines whether the electronic device 1 stops moving for a predetermined time duration (e.g., 5 seconds). When the electronic device 1 stops moving for the predetermined time duration, the determination module 104 determines that a current user gesture has been finished, and step S8 is implemented. When the electronic device 1 does not stop moving for the predetermined time duration, the determination module 104 determines that the current user gesture has not been finished, and the procedure returns to step S2.

In some embodiments, the determination module 104 times according to a timestamp of each of the movement displacements. When the recording module 102 records one movement displacement, a corresponding timestamp is also recorded, and the determination module 104 starts timing and determines whether the predetermined time duration elapses. The determination module 104 restarts timing, once the recording module 102 acquires a next movement displacement from the sensor 14.

In step S8, the determination module 104 determines that one character has been finished inputting according to the current user gesture.

In step S10, the generation module 105 determines a movement path according to the movement coordinates and a recording sequence of the movement displacements.

In step S12, the generation module 105 determines whether a character corresponding to the movement path is generated. In some embodiments, the storage device 12 pre-stores a plurality of character libraries, which may include, but are not limited to, a Chinese word library, an English alphabet library, a symbol library, a French word library, a number library, and so on. The word libraries are used to store literal codes, which can be recognized and processed by the processor 11.

The generation module 105 transforms the movement path into literal codes, determines a corresponding character by comparing the literal codes of the movement path with data in the word library, and then generates the character on the input interface 100. The generation module 105 further displays the movement path and/or the generated character on the input interface 100 of the electronic device 1. Other known technologies can be used to identify the character according to the movement path.

When the character is generated according to the movement path, step S14 is implemented. When no character is generated according to the movement path, step S16 is implemented. In other embodiments, when no character is generated, the generation module 105 may provide an error message to prompt the user of the electronic device 1 to input again.

In other embodiments, if the character input system 10 is used to input characters into the electronic device 3, step S14 is implemented. If the character input system 10 is merely used to input characters into the electronic device 1, step S14 is ignored, and step S16 is implemented.

In step S14, the transmission module 106 transmits the generated characters to a designated electronic device, such as the electronic device 3, and displays the generated characters on the display device 33 of the electronic device 3.

In step S16, the invoking module 101 determines whether the character input function has been disabled. If the character input function has been disabled, the procedure ends. If the character input function has not been disabled, the procedure returns to step S2.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for character input using an electronic device, the electronic device comprising a sensor which detects displacement parameters of the electronic device, the method comprising:
recording movement displacements of the electronic device using the sensor, under the condition that a character input function of the electronic device is invoked;
determining movement coordinates based on a predetermined coordinate system according to the movement displacements;
determining that one character has been finished inputted when the electronic device stops moving for a predetermined time duration;
determining a movement path according to the movement coordinates and a recording sequence of the movement displacements; and
generating a character corresponding to the movement path.

2. The method according to claim 1, further comprising:
presetting a hotkey to enable or disable the character input function of the electronic device.

3. The method according to claim 1, further comprising:
transmitting the generated character to a designated electronic device, which is connected to the electronic device; and
displaying the generated character on a display device of the designated electronic device.

4. The method according to claim 3, wherein the designated electronic device is connected to the electronic device through a wireless network or using a data cable, and the generated character is one of Chinese characters, alphabets, numbers, and/or symbols.

5. The method according to claim 1, further comprising:
displaying the movement path on a display device of the electronic device or providing an error message to prompt a user of the electronic device to input again, when no character is generated according to the movement path.

6. The method according to claim 1, wherein the step of determining movement coordinates based on a predetermined coordinate system according to the movement displacements comprises:
(a) determining an origin of the predetermined coordinate system to be a first point of a first movement displacement;
(b) determining a second point according to the first movement displacement and the first point;
(c) determining a third point according to a second movement displacement and the second point; and
(d) repeating steps (c) until all points corresponding to other movement displacements are determined.

7. An electronic device comprising:
a sensor which detects displacement parameters of the electronic device;
at least one processor; and
a storage devices storing a plurality of instructions, which when executed by the processor, causes the at least one processor to:
record movement displacements of the electronic device using the sensor, under the condition that a character input function of the electronic device is invoked;
determine movement coordinates based on a predetermined coordinate system according to the movement displacements;
determine that one character has been finished inputting when the electronic device stops moving for a predetermined time duration;
determine a movement path according to the movement coordinates and a recording sequence of the movement displacements; and
generate a character corresponding to the movement path.

8. The electronic device according to claim 7, wherein the at least one processor further presets a hotkey to enable or disable the character input function of the electronic device.

9. The electronic device according to claim 7, wherein the at least one processor further:
transmits the generated character to a designated electronic device, which is connected to the electronic device; and
displays the generated character on a display device of the designated electronic device.

10. The electronic device according to claim 9, wherein the designated electronic device is connected to the electronic device through a wireless network or using a data cable, and the generated character is one of Chinese characters, alphabets, numbers, and/or symbols.

11. The electronic device according to claim 7, wherein the at least one processor further displays the movement path on a display device of the electronic device or provides an error message to prompt a user of the electronic device to input again, when no character is generated according to the movement path.

12. The electronic device according to claim 7, wherein the movement coordinates are determined by:
(a) determining an origin of the predetermined coordinate system to be a first point of a first movement displacement;
(b) determining a second point according to the first movement displacement and the first point;
(c) determining a third point according to a second movement displacement and the second point;
(d) repeating steps (c) until all points corresponding to other movement displacements are determined.

13. A non-transitory storage medium having stored thereon instructions that, when executed by a processor of an electronic device, causes the electronic device to perform a method for character input using the electronic device, the electronic device comprising a sensor which detects displacement parameters of the electronic device, the method comprising:
recording movement displacements of the electronic device using the sensor, under the condition that a character input function of the electronic device is invoked;
determining movement coordinates based on a predetermined coordinate system according to the movement displacements;
determining that one character has been finished inputting when the electronic device stops moving for a predetermined time duration;
determining a movement path according to the movement coordinates and a recording sequence of the movement displacements; and
generating a character corresponding to the movement path.

14. The non-transitory storage medium according to claim 13, wherein the method further comprises:
presetting a hotkey to enable or disable the character input function of the electronic device.

15. The non-transitory storage medium according to claim 13, wherein the method further comprises:
transmitting the generated character to a designated electronic device, which is connected to the electronic device; and
displaying the generated character on a display device of the designated electronic device.

16. The non-transitory storage medium according to claim 15, wherein the designated electronic device is connected to the electronic device through a wireless network or using a data cable, and the generated character is one of Chinese characters, alphabets, numbers, and/or symbols.

17. The non-transitory storage medium according to claim 13, wherein the method further comprises:
displaying the movement path on a display device of the electronic device or providing an error message to prompt a user of the electronic device to input again, when no character is generated according to the movement path.

18. The non-transitory storage medium according to claim 13, wherein the step of determining movement coordinates based on a predetermined coordinate system according to the movement displacements comprises:
(a) determining an origin of the predetermined coordinate system to be a first point of a first movement displacement;
(b) determining a second point according to the first movement displacement and the first point;
(c) determining a third point according to a second movement displacement and the second point;
(d) repeating steps (c) until all points corresponding to other movement displacements are determined.
